(19) United States
(12) Patent Application Publication
(10) Pub. No.: US 2007/0033540 A1
(43) Pub. Date: Feb. 8, 2007

(54) Systems and methods for directory and file manipulation using a multifunction device

(75) Inventors: Amanda K. Bridges, Winchester, KY (US); William J.G. Flowers, Lexington, KY (US); Kenneth C. Napier, Lexington, KY (US); Benjamin S. Moore, Mt. Sterling, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/198,495

(22) Filed: Aug. 5, 2005

(51) Int. Cl. G11B 20/12

(52) U.S. Cl. 715/769; 369/59.25; 707/102; 711/205

(57) ABSTRACT

A method and system of rendering a graphical user interface of a multifunction device. In an embodiment, the method comprises displaying, by the multifunction device, a graphical user interface including a plurality of user-selectable elements. The user-selectable elements include at least one first element configured to trigger a directory creation process in order to create a directory in a storage device resident in or accessible to the multifunction device, and at least one second element configured to trigger a file storage process in order to store a file in the created directory of the storage device.

### CROSS REFERENCE TO RELATED APPLICATIONS

This application is related to U.S. Application No.______ , filed______, Attorney Docket No. 2004-0600.02, the entire contents of which are incorporated herein by reference.

### FIELD

Embodiments of the present invention relate generally to multifunction device (“MFD”) systems and methods. More specifically, embodiments of the present invention relate to a method and system of manipulating files and directories associated with an MFD.

### BACKGROUND

In recent years, MFDs have come into widespread use in business and home settings. Such devices provide a broader range of fuctionality than that provided by traditional single-function devices, such as dedicated printers, scanners, copiers, and facsimile machines. Often, increased functionality brings more complex data management. For example, an MFD may be able to access and utilize data from a plurality of sources (e.g., a removable storage device, an onboard storage device, a computer, a database, and the like). Many MFDs require an additional computer (e.g., a personal computer (“PC”)) to manage data from these sources. MFDs often include graphical user interfaces (“GUIs”) for controlling various functions and presenting relevant information to a user. Design and implementation of such GUIs may be complex, as a desire for increased functionality and a desire for a user-friendly experience may be in tension.

### SUMMARY

The following summary sets forth certain example embodiments of the present invention described in greater detail below. It does not set forth all such embodiments and should in no way be construed as limiting of the present invention.

In one embodiment, a method of rendering a graphical user interface of a multifunction device comprises displaying, by the multifunction device, a graphical user interface including a plurality of user-selectable elements. The user-selectable elements include at least one first element configured to trigger a directory creation process in order to create a directory in a storage device resident in or accessible to the multifunction device, and at least one second element configured to trigger a file storage process in order to store a file in the created directory of the storage device.

In another embodiment, a method of manipulating contents of a storage device of a multifunction device comprises executing, by the multifunction device, directory manipulation code configured, responsive to at least one user input, to selectively create at least one of a directory and a file in a storage device of the multifunction device. The at least one user input is receivable from a user via a graphical user interface of the device.

In yet another embodiment, a multifuiction device comprises a graphical user interface (“GUI”) display engine and a directory manipulation engine. The GUI display engine is configured to display a GUI and to interactively receive at least one input from a user. The user input is structured to specify a directory to be created in a storage device of the multifunction device. The directory manipulation engine is configured, based at least in part on the user input, to selectively create the directory on the storage device.

Other aspects of the present invention will become apparent by consideration of the detailed description and accompanying drawings.

### BRIEF DESCRIPTION OF THE DRAWINGS

FIG. 1 shows a system that includes a multifunction device according to one embodiment of the present invention.

FIG. 2 shows a block diagram of the multifunction device of FIG. 1.

FIG. 3 shows a second block diagram of the multifunction device of FIG. 1.

FIG. 4 shows a flowchart of a method of creating a directory and/or file according to one embodiment of the present invention.

FIG. 5 shows a flowchart of a method of deleting a directory and/or file according to one embodiment of the present invention.

FIG. 6 shows a screenshot of a home screen graphical user interface according to an embodiment of the present invention.

FIG. 7 shows a screenshot of a held jobs graphical user interface according to an embodiment of the present invention.

FIG. 8 shows a screenshot of a bookmarks graphical user interface according to an embodiment of the present invention.

FIG. 9 shows a screenshot of a USB drive graphical user interface according to an embodiment of the present invention.

FIG. 10 shows a screenshot of a deletion confirmation graphical user interface according to an embodiment of the present invention.

FIG. 11 shows a screenshot of a USB drive subdirectory graphical user interface according to an embodiment of the present invention.

FIG. 12 shows a screenshot of a name entry graphical user interface according to an embodiment of the present invention.

### DETAILED DESCRIPTION

Before any embodiments of the present invention are explained in detail, it is to be understood that the present invention is not limited in its application to the details of construction and the arrangement of components set forth in the following description or illustrated in the following drawings. The present invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected” and “coupled” and variations thereof are used broadly and encompass both direct and indirect connections and couplings. Further, “connected” and “coupled” are not restricted to physical or mechanical connections or couplings.

Embodiments of the present invention relate to systems and methods of providing expanded functionality for a user of a MFD. In an embodiment, a user can manipulate (e.g., create, delete, and/or modify) files and/or directories stored on the MFD with a GUI. Alternatively or additionally, the GUI can be used to manipulate files and directories that are stored in removable devices (e.g., a thumb drive), or on a network-connected database or server. It is to be appreciated that embodiments herein do not require the MFD to be connected to a PC or other device in order to manipulate files and/or directories. Embodiments herein expand the scope of useful functions an MFD can support in a user-friendly manner.

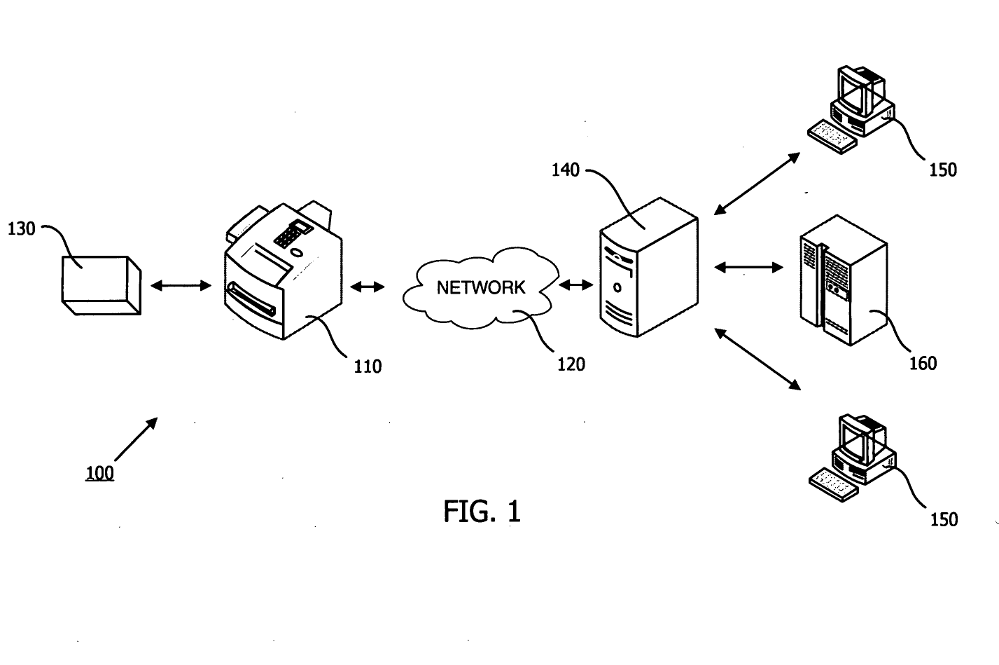

FIG. 1 shows a system 100 that includes an MFD 110. The system 100 also includes a network 120, a removable storage device 130, a server 140, PCs 150, and a database 160. The number and type of components that are included in the system 100 can vary depending on its application. For example, the system 100 may be implemented in a workplace where many more PCs 150, databases 160, and servers 140 are connected by the network 120. Multiple MFDs 110 may also be implemented in the system 100.

The MFD 110 can represent a multifunction device such as a printer, scanner, facsimile machine, copier, or combination thereof. In an embodiment, the MFD 110 may be similar, in certain respects, to an X820e MFD, developed by Lexmark International, Inc. (Lexington, Ky.).

The network 120, such as a LAN or WAN, can be used to connect a plurality of devices (e.g., a PC 150, a database 160, a server 140, etc.) to the MFD 110. The network 120 can include wireless and/or wireline connections between components. In one embodiment, the server 140 is a document server that interacts with the MFD 110 to perform special functions on electronic documents. For example, the MFD 110 may interact with the server 140 in order to email electronic documents scanned by the MFD 110 to a desired electronic address accessible via the network 120. As another illustrative example, the MFD 110 may receive print requests from the server 140. Thus, the network 120 may represent a LAN that is in communication with a WAN, such as the Internet. The server 140 may also include specialized functions for setting up and controlling the operations of the MFD 110. It should also be apparent to those of ordinary skill that it is within the scope of the present invention that the server 140 and MFD 110 may be combined into a single unit operatively coupled to the network 120.

The removable storage device 130 can electronically store a variety of data (e.g., text files, pictures, Uniform Resource Locators (“URLs”), and the like) so that it can be used by multiple devices. For example, in an embodiment, the removable storage device 130 is a thumb drive that can be inserted into a universal serial bus (“USB”) port of a PC that is not connected to the network 120, and data from the PC can be transferred to the thumb drive. After the data has been transferred, the thumb drive can be removed from the USB port of the PC and taken to another device, such as the MFD 110. By inserting the thumb drive into a USB port of the MFD 110, the stored data on the thumb drive can be used by, or transferred to, the MFD 110. Alternatively, other devices (e.g., a flash memory card) can be used to share data between electronic components.

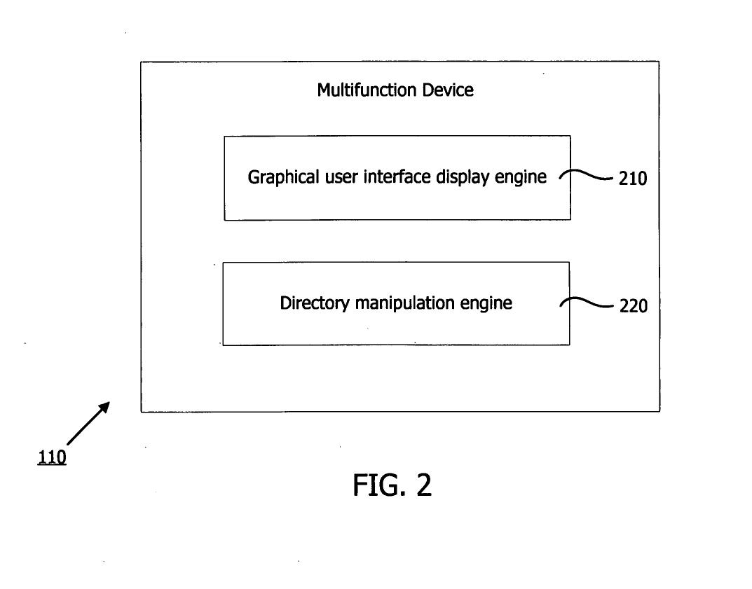

FIG. 2 shows an embodiment of the MFD 110. (FIG. 1) that includes a GUI display engine 210 and a directory manipulation engine 220. The GUI display engine 210 displays a GUI that interactively receives inputs from a user. In one embodiment, the GUI is an icon-based touch screen (or similar display) that is incorporated into the MFD 110. Alternatively, the GUI can include other types of moveable-cursor-based interfaces, which would typically necessitate the use of a cursor-control device such as a mouse, a roller ball, or other similar device. Additionally, the GUI display engine 210 may include GUI software that operates in accordance with conventional windowing GUI paradigms.

Input from the GUI display engine 210 can be used to create, delete, rename, move, or otherwise manipulate a directory in a storage device associated with the MFD 110. More specifically, in one embodiment, commands received by the GUI display engine 210 can be used by the directory manipulation engine 220 to create a directory on a storage device associated with the MFD 110. Such a storage device can include a memory of the MFD 110, a memory of one of the PCs 150, a memory of the server 150, the removable storage device 130, etc. To facilitate the manipulation of directories, the GUI can display the contents of a directory file system of the storage device. For example, in one embodiment, the GUI is used to view the directories, subdirectories, and files that are stored on the removable storage device 130. Alternatively or additionally, the GUI display engine 210 and directory manipulation engine 220 can be used to manipulate (e.g., delete, move, rename, etc.) files (e.g., text files, picture files, etc.) associated with the MFD 110.

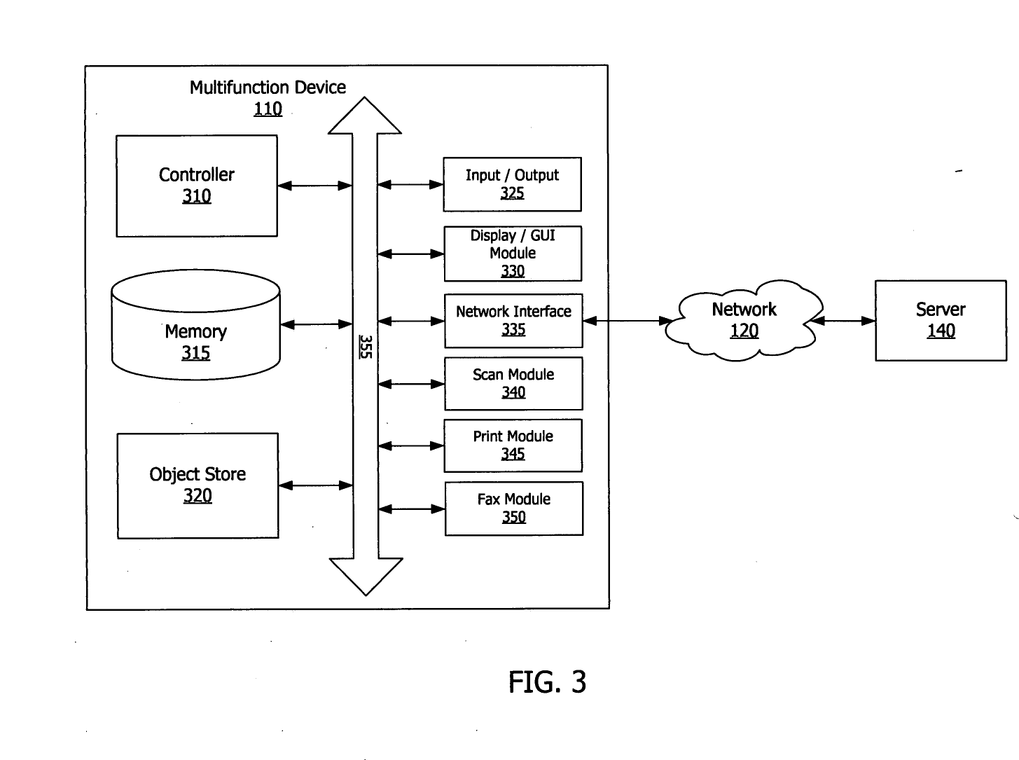

FIG. 3 shows an exemplary implementation of the MFD 110 of FIG. 1. In an embodiment, the MFD 110 generally includes a controller 310, a memory 315, an object store 320, an input/output (“I/O”) interface 325, a display/GUI module 330 (also referred to herein as the “GUI module”), a network interface 335, a scan module 340, a print module 345, and a fax module 350, each of which may communicate with each other via a bus 355.

The print module 345, scan module 340, and fax module 350 may implement the printing, scanning, and fax functions, respectively, of the MFD 110. According to an embodiment of the present invention, the print module 345 includes, for example, the necessary hardware and/or software that allow the MFD 110 to print documents, including those submitted to the MFD 110 via the network 120 and the network interface 335. Similarly, the scan module 340 includes the necessary hardware and/or software for scanning tangible documents on the MFD 110 and storing the scanned electronic documents in the memory 315. The electronic documents may also be stored in a local attached memory device such as the removable storage device 130, or in a remote memory on or in communication with the MFD 110 (e.g., a PC 150 on the network 120). Likewise, the fax module 350 includes the necessary hardware and/or software for faxing electronic documents over a telephone line (not illustrated) or the like. The fax module 350 may also have an internal scanning device for scanning tangible documents or may interact with the scan module 340 to scan tangible documents and fax documents over a telephone line.

In an embodiment, the print module 345, scan module 340, and fax module 350 operate in conjunction with the controller 310, which handles at least a portion of the processing required to effect the printing, scanning, and faxing functions of the MFD 110. For example, the scan module 340 may include a scan manager, and the print module 345 may include a print engine, where the scan manager and print engine operate in conjunction with the controller 310 to handle printing and scanning processing, respectively. Similarly, the fax module 350 may include a fax engine and/or additional software and hardware for implementing fax functions, as are known in the art, or may also utilize processing implemented by the controller 310 to effect fax functions.

It should be appreciated that the components described herein with respect to FIGS. 2 and 3 may include computer-executable software running in conjunction with computer hardware. For example, as illustrated in FIG. 3, and as described below, the print module 345, scan module 340, fax module 350, and GUI module 330 may include computer-executable programs (i.e., software) stored within one or more memories of the MFD 110 that are executed by the controller 310 to effect the functions described herein. Furthermore, the print module 345, scan module 340, and fax module 350 can include any suitable electronic and mechanical elements that together effect printing, scanning, and faxing functions, respectively, of the type that conventionally occur in commercially available multifuiction machines, such as the X820e (described above). Such elements are well-understood by persons skilled in the art to which the present invention relates. Therefore, details of the print module 345, scan module 340, and fax module 350, including mechanical and other details of the manner in which they are constructed and communicate with one another and other elements to perform conventional printing, scanning, and faxing functions, are not described herein.

The controller 310 may be a processor that executes computer-executable programs with the aid of an operating system (not illustrated). According to other embodiments, one or more of the components illustrated in FIGS. 2 and 3 comprise hardware, such that the functions described herein are performed by hardware components. For instance, the controller 310, print module 345, scan module 340, fax module 350, and/or GUI module 330 may be implemented by an application-specific integrated circuit (“ASIC”), firmware, dedicated components, or the like, as are known in the art. Thus, it will be appreciated that the MFD 110 may be implemented in an embodiment combining software and/or firmware and hardware, or in an embodiment comprised entirely of hardware. Additionally, one or more of the components illustrated in the MFP 110 of FIGS. 2 and 3 may be combined to implement the methods and functions described herein.

The MFD 110 is illustrated in FIG. 3 as being operatively coupled to (i.e., in communication with) the network 120 via the network interface 335. The connection of the MFD 110 to the network 120 enables the MFD 110 to communicate with remote computing devices, such as PCs 150.

The MFD 110 includes at least one memory 315 operable to store data created or received by the MFD 110 via the network 120 and the network interface 335. The memory 315 may include ROM, RAM, optical media, or other storage, as are well known in the art. According to an embodiment of the present invention, the memory 315 is operable to store files, directories, and metadata, as described below. In some embodiments, files and directories are organized and stored as containers and work flow objects. Additionally, although illustrated as separate from the object store 320, at least a portion of the memory 315 may be located within the object store 320. Thus, according to an exemplary embodiment, the object store 320 may hold containers, work flow objects, metadata, and other data. According to one aspect of the present invention, the memory 315 may also store data, such as work flow objects, uploaded to the memory 315 from the removable storage device 130 via the I/O interface 325. The removable storage device 130 may permit the MFD 110 to read/write (RJW) data to and from the removable storage device 130. For example, the MFD 110 may receive a .PDF type document from the removable storage device 130 inserted into the I/O interface 325, or transfer a .PDF document to the removable storage device 130. According to one aspect of the present invention, such a removable storage device 130 may also be a read-only device, such as a read-only CD drive.

As is also shown in FIG. 3, the MFD 110 includes a GUI module 330 that controls the display of information on a display or GUI, which may be part of the MFD 110. The GUI module 330 includes numerous features, such as those described herein, to enable users to access, store and organize directories and files. More specifically, the GUI module 330 works in conjunction with the object store 320 to enable users of the MFD 110 to retrieve, store, and organize directories and files that may be created, stored, and/or transmitted to or from the MFD 110. The GUI module 330 can also work in conjunction with the object store 320 and the I/O module 225 to retrieve, store, and organize directories and files of the removable storage device 130. The manipulation of such directories and files is enabled using GUIs presented to the user via the GUI module 330. The storage and organization of such objects is handled by the object store 320 in conjunction with the controller 310. In one embodiment, the MFD 110 is implemented using the “C” and “XML” languages known in the art.

The MFD 110 shown in FIG. 3 is only one exemplary embodiment. Therefore, one or more of the MFD 110 components described herein may be combined and/or placed external to the MFD 110, including remote from the MFD 110. Additionally, although described herein as a multifunction device, one or more of the components may be optional or unnecessary. For instance, the MFD 110 may represent a device that does not include a fax function so that the MFD 110 may not include a fax module 350. Furthermore, although described herein as a MFD 110, according to an embodiment of the present invention, the MFD 110 may alternatively have only a single or dedicated function, such as a scanning function requiring only the scan module 340. Other embodiments of the MFD 110 are possible. For instance, although the print module 345, scan module 340, fax module 350, and GUI module 330 are illustrated as independent components, each may be stored within one or more memories of the MFD 110, such as the memory 315, and each may be stored in whole or part external to the MFD 110 and fetched into memory 315 on an as-needed basis. Other software elements of the types conventionally included in PCs, such as an operating system and communication software, may also be included, but are not shown for purposes of clarity.

In an embodiment, the GUI module 330 is configured to enable a user to manipulate (e.g., create, delete, rename, move, etc.) files and/or directories in a plurality of locations, as previously described. For example, the GUI module 330 can be used to manipulate files and directories that are stored in the memory 315 of the MFD 110, the removable storage device 130, and other remote locations, such as one of the PCs 150.

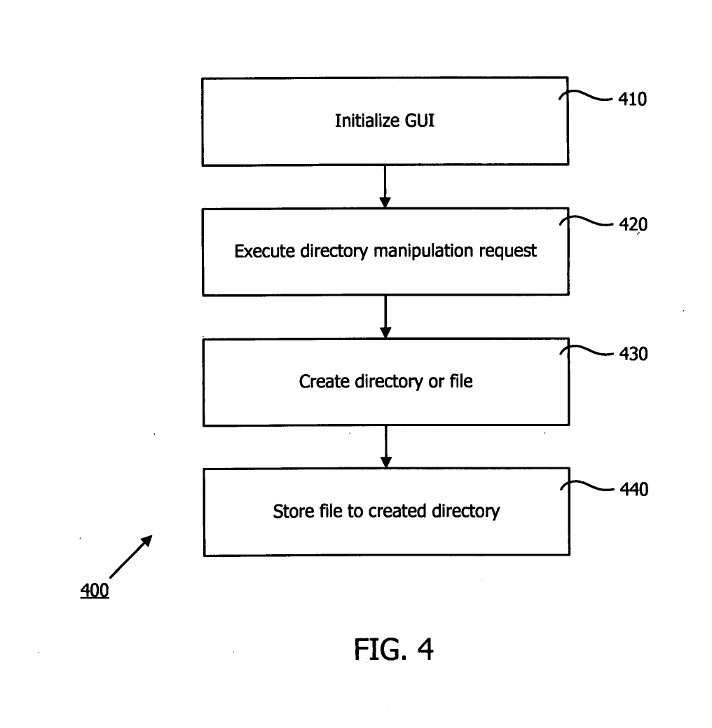

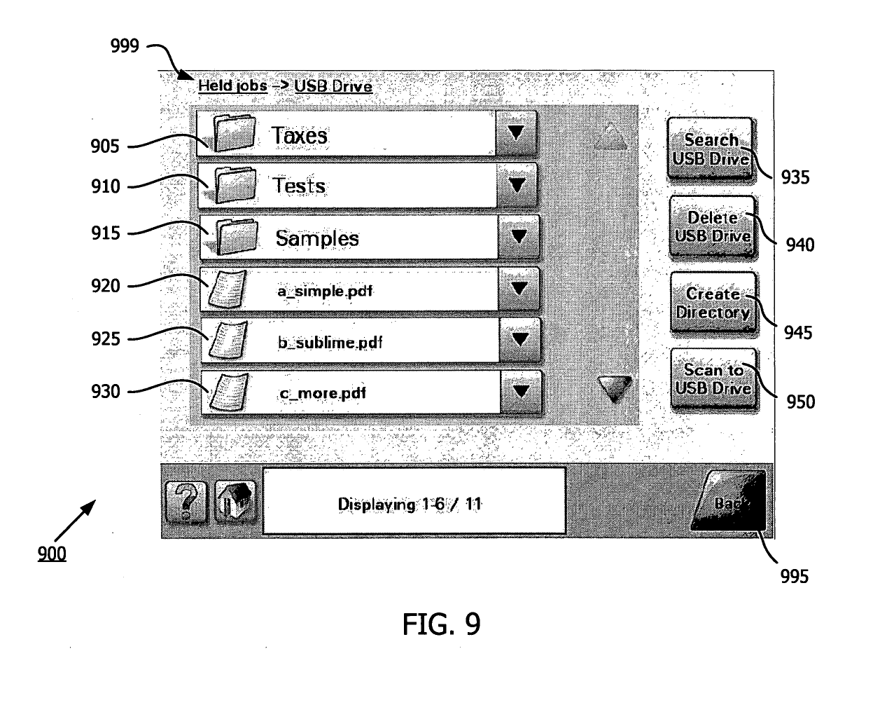

FIG. 4 shows a process 400 of creating a file or directory according to an embodiment of the present invention. The GUI module 330 is first initialized, which may occur, for example, when the user turns on the MFD 110 (step 410). Using inputs (e.g., action buttons) displayed by the GUI module 330, a user can then execute a directory or file manipulation request (step 420), and the directory or file is created (step 430). More specifically, in an embodiment, the user chooses a destination path with the GUI module 330, as well as a name for the directory or file to be created. Alternatively, the GUI module 330 may assign a default identifier to the newly created directory or file. The destination path may be the memory 315 of the MFD 110, the removable storage device 130, or another remote location. If a new directory is created (step 430), a file can then be saved to the newly created directory (step 440). For example, the user can choose a “Scan to” option with the GUI (see FIG. 9) to save a scanned image to the newly created directory. In other embodiments, the process 400 may be carried out using additional or fewer steps. For example, a user may scan a document prior to choosing a destination path and directory for the scanned document.

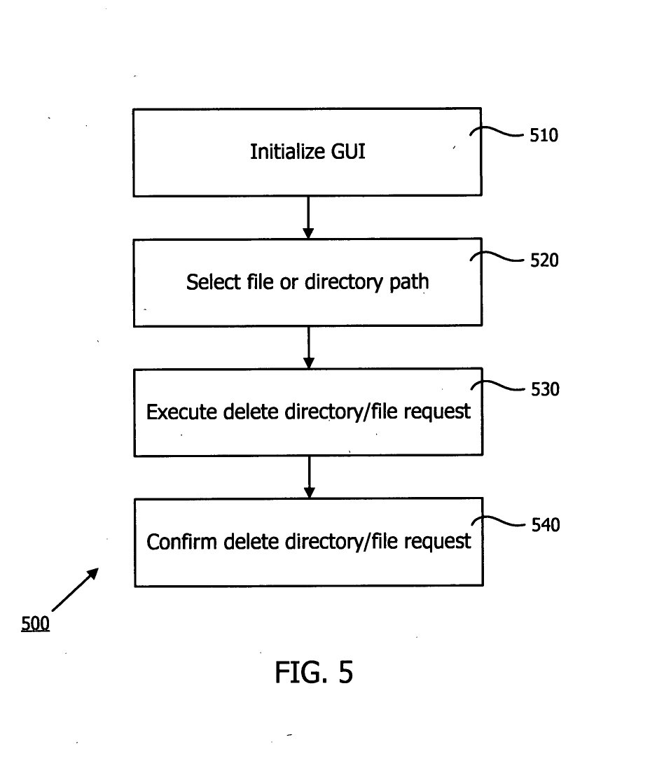

FIG. 5 shows a process 500 of deleting a file or directory. The GUI is first initialized (step 510), and the path of the directory or file that is to be deleted is selected (step 520). In some embodiments, the user can use a search function of the GUI to search for the desired file or directory using the file or directory name. After locating the file or directory that is to be deleted, the user can execute a request to delete the file using the GUI (step 530). To complete the deletion of the file or directory, the deletion request may need to be confirmed (step 540). The confirmation step may help the user avoid deleting files and

directories by accident. If a directory is chosen to be deleted, the entire contents of the directory are also deleted.

In an embodiment of the present invention, an MFD has an architecture that employs containers and work flow objects, such as the architecture described in the previously incorporated related patent application. Other architectures may be employed, such as, for example, architectures employing flat files or databases, or other architectures capable of searching and sorting data to provide functions described herein (e.g., grouping items, representing grouped items on a GUI, etc.).

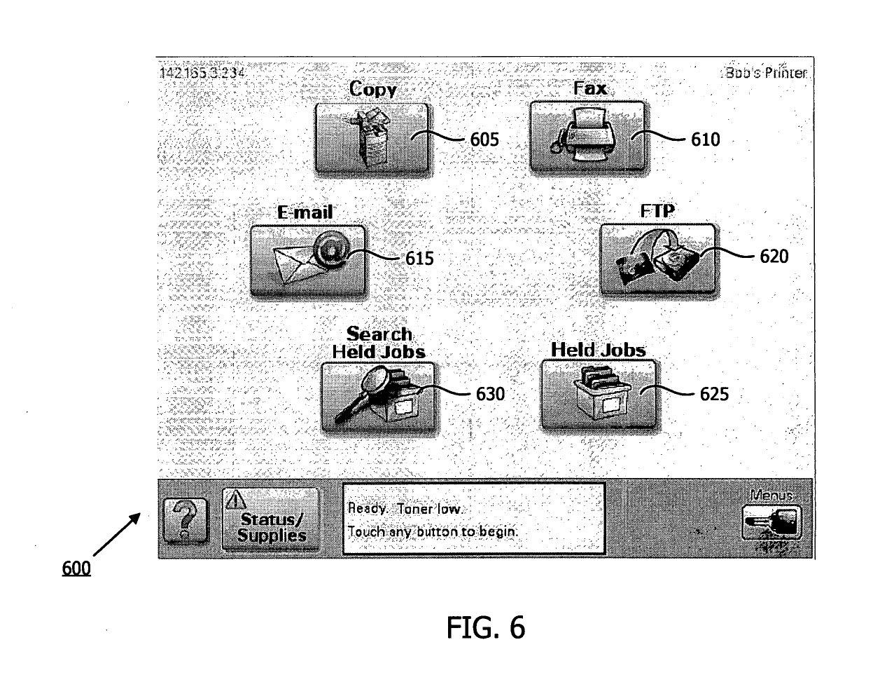

FIGS. 6-12 depict screenshots of exemplary GUIs according to embodiments of the present invention. The GUIs can be used to manipulate directories and files. Although FIGS. 6-12 relate to an MFD architecture involving containers and work flow objects, it is to be appreciated that GUIs can be implemented in any of various other ways within the scope of embodiments herein.

FIG. 6 shows a home screen GUI 600 that may be presented to users by the MFD 110, according to an embodiment of the present invention. The home screen GUI 600 includes icons allowing a user to activate several basic functions of the MFD 110. According to one aspect of the present invention, the icons may be selected by touch, where the GUI module 330 (FIG. 3) includes a touch screen display. As shown in FIG. 6, these basic functions may include, for example, a faxing function represented by a “Fax” icon 610, a copying function represented by a “Copy” icon 605, a scan-to-email function represented by an “Email” icon 615, and an file transfer protocol (FTP) function represented by an “FTP” icon 620. Upon selecting the fax icon 610, the GUI will then provide a GUI that includes icons and associated fields for allowing the user to fax an electronic document stored by or scanned into the MFD 110 over the network 120 or a telephone line. Upon activating the Copy icon 605, the GUI will advance to a graphical interface providing icons and fields for controlling the copying functions of the MFD 110. Similarly, upon activating the Email icon 615, the GUI will provide an interface for allowing the user to type in an email message and attach electronic documents (e.g., stored by the MFD 110, scanned by the MFD 110, stored on the server 140, or available over the network 120) to the email message, and send that email to an electronic address over the network 120.

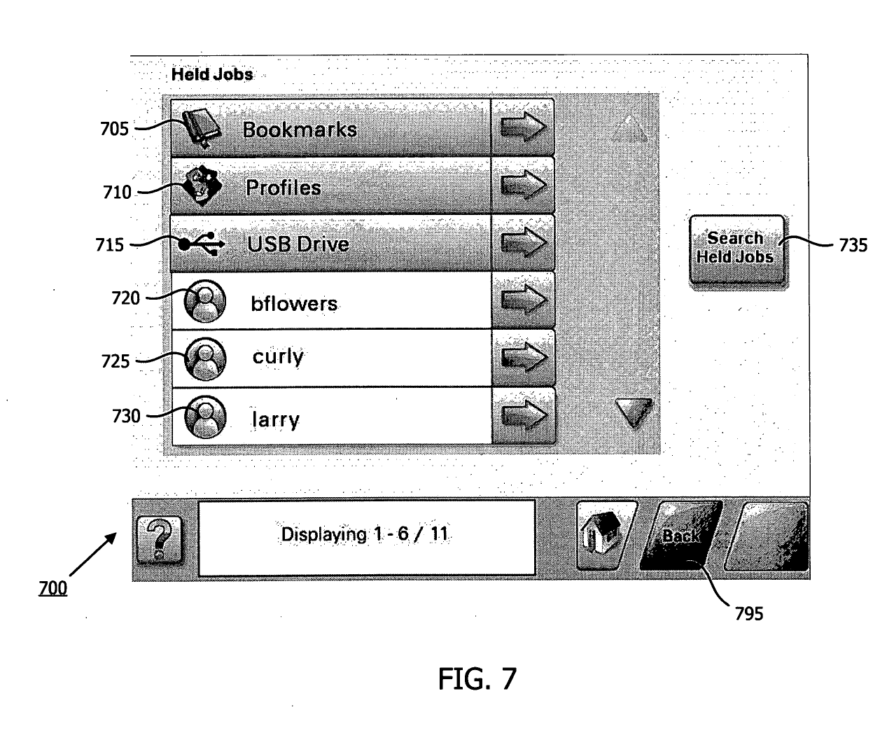

As shown in FIG. 6, the home screen GUI 600 also includes a “Search Held Jobs” icon 630 and a “Held Jobs” icon 625. According to the illustrative embodiment of FIG. 6, the Held Jobs icon 625 represents a held jobs container, under which all workflow objects and containers are accessible. Thus, the home screen GUI 600 permits a user to access the containers and workflow objects managed by the object store 320 of the MFD 110. According to an embodiment, the held jobs container may be the default container for all other containers, and the selection of the Held Jobs icon 625 will open a GUI showing the workflow objects and containers within it, as described below with respect to FIG. 7. According to one aspect of the present invention, whenever the held jobs container includes any items, such as one or more workflow objects or containers, the Search Held Jobs icon 630 will also be presented on the home screen GUI 600. The selection of the Search Held Jobs icon 630 will open a search GUI (not shown).

FIG. 7 shows a “Held Jobs” GUI 700, according to an exemplary embodiment. The Held Jobs GUI 700 is presented to a user via the GUI of the MFD 110 after the user selects the Held Jobs icon 625 of the home screen GUI 600. The Held Jobs GUI 700 displays one or more containers and/or workflow objects that are stored within the held jobs container (as described in FIG. 6). In one embodiment, default containers and/or containers that correspond to external applications, such as the bookmark container 705 and the profiles container 710, may be listed first. Those containers are followed by icons for user-specific containers 720-730. Additionally, a container 715 may be included that corresponds to a removable storage device 130 (such as a USB thumb drive). In some embodiments, unless specifically disabled, the user can scan to or save documents to the removable storage device 130 at each directory level (i.e., container level). As described above, the user-specific containers 720-730 may be generated automatically based on the identity of a user's computer submitting a job to the MFD 110. According to one aspect of the present invention, user-specific containers 720-730 may be listed in alphabetical order. The user-specific containers 720-730 may also be followed by workflow objects (not illustrated).

A user may choose a container within the Held Jobs GUI 700 by selecting it, as may be accomplished via a touch screen, a mouse, or keys, for example, as is known in the art. Selecting a container will open another GUI that corresponds to that particular container, as illustrated below. Though not illustrated in FIG. 7, according to another embodiment, a user may also execute workflow objects presented by the Held Jobs GUI 700 by selecting the workflow object. Additionally, a user may select a Search Held Jobs icon 735, which will direct the user to the same location as the Search Held Jobs icon 630 of FIG. 6.

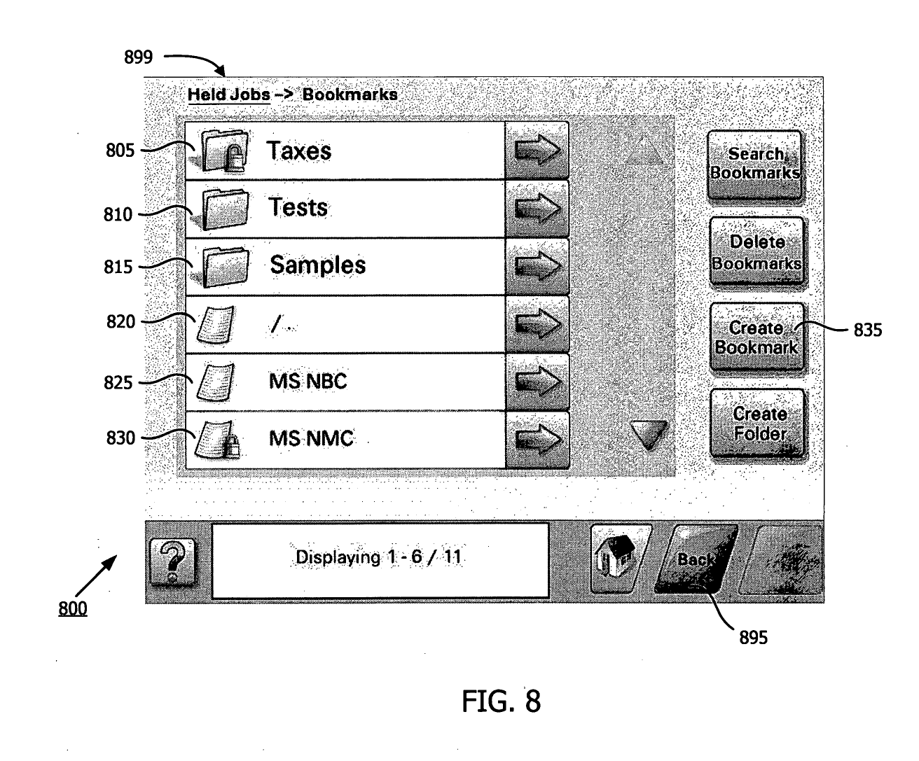

The held jobs container of the Held Jobs GUI 700 may include a bookmark container 705, as previously described. According to an aspect of the present invention, the bookmark container 705 may include popular, commonly accessed containers and workflow objects. Upon selecting the bookmark container 705, a “Bookmarks” GUI 800 (see FIG. 8) is provided to the user. As with other containers, the bookmark container 805 can include sub-containers as well as workflow objects that, when selected, initiate an action, such as printing a page. The workflow objects within the bookmark container 805 may be referred to as bookmarks. In the illustrative example of FIG. 8, the Bookmarks GUI 800 includes three containers 805, 810, 815 and at least three workflow objects (or bookmarks) 820, 825, 830. The Bookmarks GUI 800 may also include at least one icon permitting a user to execute a search of the bookmarks 820-830, which may direct the user to a search GUI (not shown), which may then be used to search only containers and workflow objects within the bookmark container 805.

As with any screen listing containers and workflow objects, containers may be displayed first, followed by workflow objects. As also illustrated in the Bookmarks GUI 800, confidential items, such as the confidential container “Taxes” 805, may be illustrated with an icon representing a folder and a lock. Containers 810, 815 that are not confidential may be illustrated with an icon representing a folder. Both containers and workflow objects may be represented based on their type. For instance, where workflow objects represent documents that may be printed, they may be represented by an icon representing a piece of paper. As another example, where a container is associated with a particular user profile, it may be represented by an icon representing a person, such as the icons for user-specific containers 720-730 in the Held Jobs GUI 700 described above.

When a user selects a container or workflow object from the Bookmarks GUI 800, the MFD 110 may display the contents of the container or execute the bookmark. As an illustrative example, a “MS NBC” workflow object may represent a document. According to an embodiment, bookmarks may be printed or deleted. In another embodiment, a user can choose to create a bookmark using a “Create Bookmark” icon 835. After the Create Bookmark icon 835 is selected by the user, a new name GUI window (not shown) is displayed.

Referring back to FIG. 7, selecting the “Profiles” container 710 can load a Profiles GUI (not shown). Profiles can correspond to certain settings and preferences that are selected by a user. For example, a user may want to perform a specific task multiple times, such as scanning a document from the MFD 110 to the PC 150. Therefore, the settings used to perform that task can be saved into a profile so that the MFD 110 loads those settings upon selection. After a profile is selected using a profiles list, the settings that correspond to the selected profile are applied to the MFD 110 automatically.

In another embodiment, selecting the containers 720-730 from the Held Jobs GUI 700 of FIG. 7 loads a user-specific container GUI (not shown).

The Held Jobs GUI 700 may also include containers or work flow objects that correspond to external storage devices 130. For example, as shown in FIG. 9, the MFD 110 may display a “USB Drive” GUI 900 for displaying the containers and workflow objects stored within a storage device, such as a flash drive, connected to the MFD 110 via a USB. Thus, upon attaching a USB device to the MFD 110, the controller 310 may identify the device. Upon requesting the USB Drive GUI 900, the object store 320 will read the contents of the USB device and display the contents via the USB Drive GUI 900. In the embodiment of FIG. 9, the USB Drive GUI 900 includes three containers 905-915 and at least three workflow objects 920-930. Similar to the Bookmarks GUI 800, the USB Drive GUI 900 may also include at least one search icon 935 permitting a user to execute a search of the USB drive containers and workflow objects, which may direct the user to a search GUI (not shown), which may then be used to search only containers and workflow objects within the USB drive.

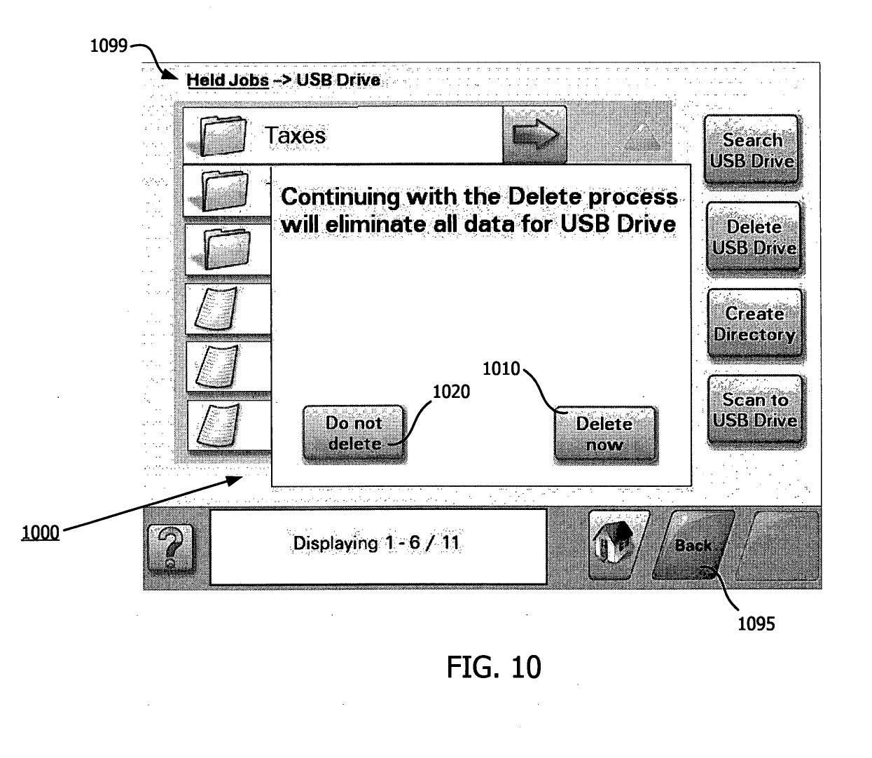

The USB Drive GUI 900 also includes a “Delete USB Drive” icon 940 permitting a user to delete contents of the USB device. Upon selecting a delete function via the selection of the Delete USB Drive icon 940, a user may be requested to confirm deletion. A deletion request window or Deletion Confirmation GUI 1000 is shown in FIG. 10. The user is prompted to select the “Delete now” icon 1010 to confirm the deletion request and remove the selected contents from the removable storage device 130 (i.e., the USB device). However, the user may also select the “Do not delete” icon 1020 to avoid deleting the contents of the USB device. If the button 1020 is selected, the GUI module 330 may return to the USB Drive GUI 900.

Referring back to FIG. 9, the user may also create a new directory via the selection of a “Create Directory” icon 945. This may allow the creation of a container stored local to the MFD 110 and managed by the object store to which the USB contents may be copied. According to another embodiment, a directory, or container, may also be created that is local to the USB drive. Allowing the user to manipulate the contents of the USB drive by creating new directories, and saving documents to those directories, eliminates the need for an additional device, such as the PC 150, to organize and save data on the USB device.

As also shown in FIG. 9, the user may scan to the USB drive via selection of the Scan to USB Drive icon 950. This allows, for example, the user to store a scanned image of a document scanned by the MFD 110 on the USB device. In an embodiment, the selection of the Scan to USB Drive icon 950 may cause a properties GUI (not shown) to be displayed, which provides the user with a plurality of options that can be used to manipulate the scan job, prior to it being sent to and saved on the USB device. The properties GUI may include an advanced options icon to cause an advanced options GUI (not shown) to be displayed by the GUI module 330. The advanced options GUI can include a plurality of icons that are used to further manipulate the scan job that was initiated by selecting the Scan to USB Drive icon 950.

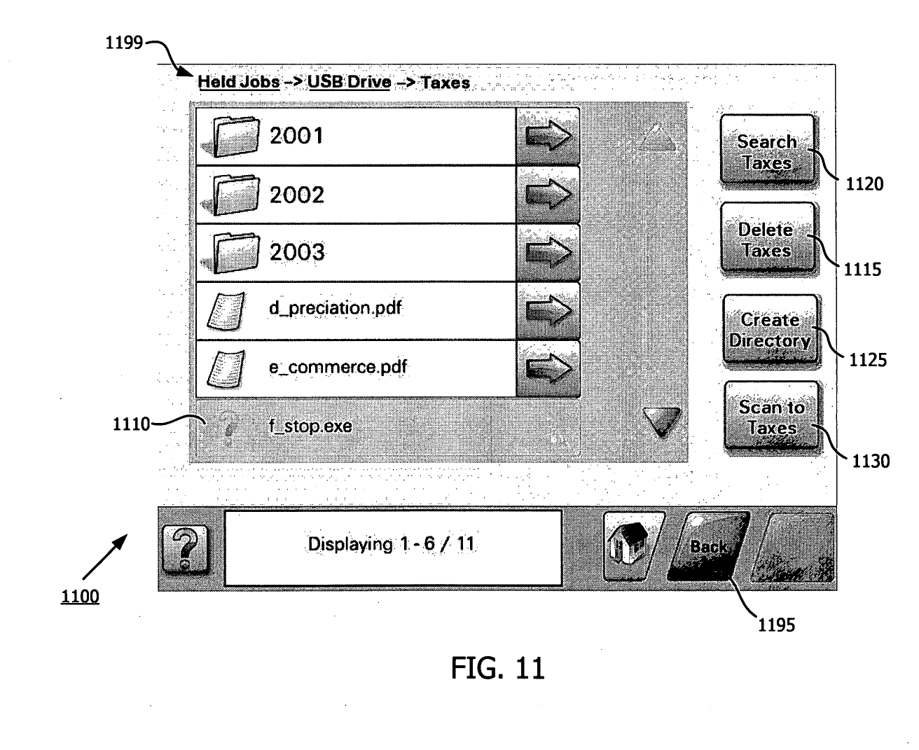

FIG. 11 shows a USB Drive Subdirectory GUI 1100. In the embodiment shown in FIG. 11, the subdirectory is named “Taxes.” A file 1110 within the USB device may have an extension that is not recognized by the MFD 110. According to one aspect, the file 1110 is illustrated in the USB Drive Subdirectory GUI 1100, but its file type is not recognized as being associated with a function of the MFD 110. As such, in this aspect, the file, while visible, cannot be selected by a user input (e.g., a touch of the screen of the MFD 110), and an attempted user input only returns an error notification (e.g., a beep, error message, etc.). According to an alternative aspect, the file 1110 is not displayed by the USB Drive Subdirectory GUI 1100. According to yet another aspect of the present invention, the file may be displayed and selected, wherein the selection of the file permits the deletion of the file via the selection of a deletion icon 1115 (such as a “Delete Taxes” icon). Prior to being deleted, however, the user may have to confirm the deletion request using a deletion request window similar to the deletion request window shown in FIG. 10. A search icon 1120, a create directory icon 1125, and a scan to icon 1130 are also included in the USB Drive Subdirectory GUI 1100.

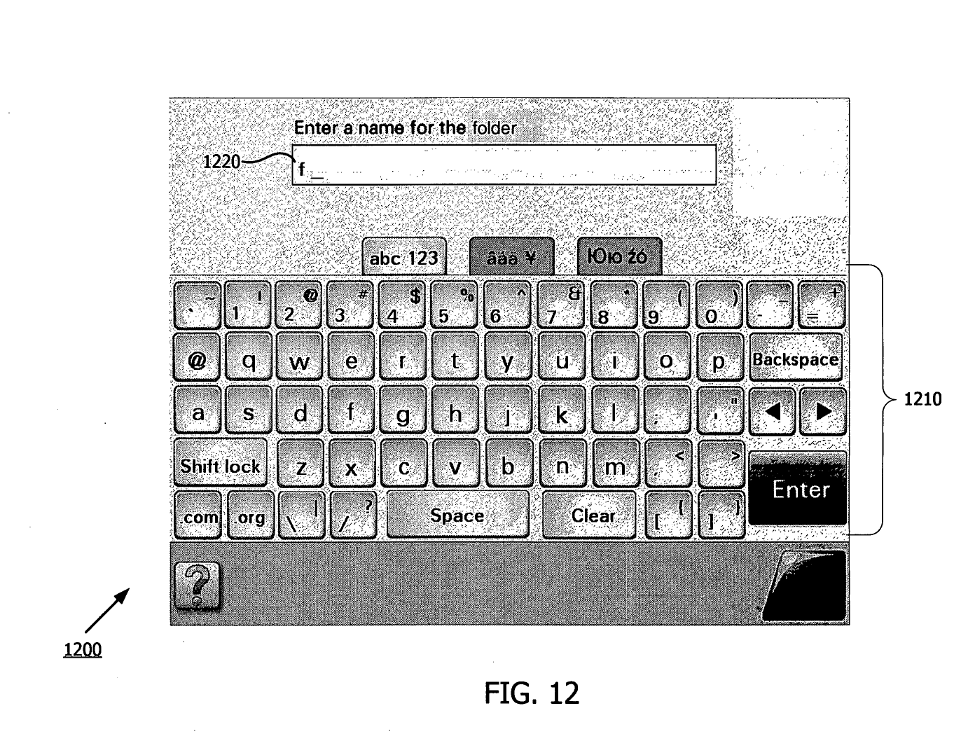

The icons 1120-1130 of FIG. 11 function similarly to the search, create directory, and scan to icons included on other GUIs described herein. For example, the scan to icon 1130 can be used to scan an image of a document from the MFD 110 to the USB drive subdirectory (e.g., the “Taxes” subdirectory shown in USB Drive Subdirectory GUI 1100). In another example, the create directory icon 1125 can be selected to create a directory in the USB drive subdirectory. Selecting the create directory icon 1125 may cause the GUI module 330 to initialize a name entry GUI 1200, as shown in FIG. 12. In an embodiment, the name entry GUI 1200 has a keyboard 1210 that includes user-selectable numbers and characters with which a user can enter a directory, folder, or container name. The numbers and characters that are selected are shown in the display area 1220. After selecting the name for the directory with the keyboard 1210, the enter icon (included in the keyboard 1210) can be used to assign the name to the directory, completing the directory creation process. In some embodiments, after the user assigns a name to a new directory using the name entry GUI 1220, the GUI module 330 returns to the USB Drive Subdirectory GUI 1100, and the newly created directory is included in the list of containers.

It is to be appreciated that, while FIGS. 9-12 relate to a removable storage device (i.e., a USB thumb drive), similar embodiments may be provided to enable directory or file manipulation functions for other memory locations, such as memory resident in an MFD 110 (e.g., a hard drive or flash memory) or memory accessible via a network.

Navigating through each of the above-described GUIs may be achieved using back icons 795, 895, 995, 1095, 1195 on the GUIs, and/or using the directory links at the top of each GUI. Thus, each of the underlined directory links 899, 999, 1099, 1199 will permit a user to navigate to the GUI representing the location identified by the directory link, similar to an HTML link on a web page. Further, each of the GUIs of the present invention may include such directory links. As an illustrative example, selecting on the ‘Held Jobs’ portion of the directory link 1199 in the USB Drive Subdirectory GUI 1100 will navigate the user to the Held Jobs GUI 700, while selecting the ‘USB Drive’ portion of the directory link 1199 in the USB Drive Subdirectory GUI 1100 will navigate the user to the USB Drive GUI 900. Additionally, the user can return to the home GUI 600 by selecting the home button in the lower corner of any of the other GUIs.

Various features and advantages of the present invention are set forth in the following claims.

1. A method of rendering a graphical user interface of a multifunction device, comprising:
displaying, by the multifuiction device, a graphical user interface including a plurality of user-selectable elements, the user-selectable elements including
(i) at least one first element configured to trigger a directory creation process in order to create a directory in a storage device resident in or accessible to the multifunction device, and
(ii) at least one second element configured to trigger a file storage process in order to store a file in the created directory of the storage device.

2. The method of claim 1, wherein the user-selectable elements are selectively displayed based on a plurality of work flows defined by software of the multifunction device.

3. The method of claim 1, wherein the multifunction device comprises a multifunction printer (MFP).

4. The method of claim 1, wherein the directory comprises a container.

5. The method of claim 1, wherein the storage device comprises a portable device interfaced with the multifunction device.

6. The method of claim 5, wherein the portable device comprises a USB thumb drive.

7. The method of claim 1, wherein the file storage process comprises:
scanning a physical document to generate the file; and
storing the file in the created directory.

8. The method of claim 1, wherein the user-selectable elements include at least one third element configured to trigger a directory deletion process in order to delete a directory in the storage device.

9. The method of claim 8, wherein a directory cannot be deleted based on only a single user input.

10. The method of claim 1, wherein the graphical user interface further includes a graphical representation of contents of the created directory.

11. The method of claim 1, wherein at least some of the user-selectable elements comprise action buttons.

12. A method of manipulating contents of a storage device of a multifunction device, comprising:
executing, by the multifunction device, directory manipulation code configured, responsive to at least one user input, to selectively create at least one of a directory and a file in a storage device of the multifunction device,
wherein the at least one user input is receivable from a user via a graphical user interface of the multifunction device.

13. The method of claim 12, wherein the multifunction device comprises a multifunction printer (MFP).

14. The method of claim 12, wherein the created file comprises a scanned document.

15. The method of claim 12, wherein the created file comprises a bookmark.

16. The method of claim 12, wherein the directory manipulation code is further configured to selectively delete at least one of a directory and a file in the storage device.

17. The method of claim 12, wherein the storage device is external to the multifunction device.

18. A multifunction device, comprising:
a graphical user interface (GUI) display engine configured to display a GUI and to interactively receive at least one input from a user, the user input structured to specify a directory to be created in a storage device of the multifunction device; and
a directory manipulation engine configured, based at least in part on the user input, to selectively create the directory on the storage device.

19. The multifunction device of claim 18, wherein elements of the GUI are displayed based at least in part on stored multifunction device work flows.

20. The multifunction device of claim 18, wherein the displayed GUI includes contents of a directory file system of the storage device.
